(19) United States
(12) Patent Application Publication
(10) Pub. No.: US 2014/0358752 A1
(43) Pub. Date: Dec. 4, 2014

(54) TRANSACTION MONITORING TO ENSURE POLICY COMPLIANCE

(71) Applicant: Bank of America Corporation, Charlotte, NC (US)

(72) Inventors: Anne M. Holt, Charlotte, NC (US); Robert J. Dominguez, High Point, NC (US); Utkal Kumar, New Delhi (IN)

(73) Assignee: Bank of America Corporation, Charlotte, NC (US)

(21) Appl. No.: 13/903,707

(22) Filed: May 28, 2013

(51) Int. Cl. G06Q 40/02

(52) U.S. Cl. CPC G06Q 40/02
USPC 705/35

(57) ABSTRACT

Methods, systems, and computer-readable media for analyzing banking transactions are presented. Banking transaction data corresponding to a banking transaction may be collected. Identification data associated with the individual that performed the transaction as well as the account involved in the transaction may be obtained. The first identification data may be compared to the second identification data to determine whether the first identification data matches the second identification data. Banking transaction analysis data may be generated. The banking transaction analysis data may identify the banking transaction as a potential policy violation when the first identification data matches the second identification data.

### TECHNICAL FIELD

Aspects of the present disclosure generally relate to monitoring transactions and particularly relate to monitoring banking transactions in order to ensure policy compliance.

### BACKGROUND

Banking institutions are dedicated to protecting the assets of their customers. In addition, banking institutions are dedicated to preserving the relationship of trust maintained with their customers. Pursuant to these interests, banking institutions implement internal policies to achieve these goals. Such policies define the permitted or prohibited activities of employees, partners, contractors, and the like. Upon detection of a potential policy violation, banking institutions swiftly respond to investigate the potential violation and take appropriate remedial and disciplinary action if necessary.

The internal policies of a banking institution may, in part, be directed towards the various banking transactions employees perform. Some banking institutions may employ thousands of individuals who collectively perform thousands—if not millions—of daily transactions. Monitoring all of these transactions for potential policy violations can pose numerous challenges, including logistical challenges.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects of the disclosure provide more efficient and effective techniques for monitoring banking transactions in order to identify, investigate, and respond to transactions that potentially violate internal policies. According to one or more aspects, computer-implemented methods of analyzing banking transactions are provided. Banking transaction data corresponding to a banking transaction may be collected. Identification data associated with the individual that performed the transaction as well as the account involved in the transaction may be obtained. The first identification data may be compared to the second identification data to determine whether the first identification data matches the second identification data. Banking transaction analysis data may be generated. The banking transaction analysis data may identify the banking transaction as a potential policy violation when the first identification data matches the second identification data.

According to one or more additional aspects, transaction analysis systems are also provided. A banking transaction server may collect banking transaction data corresponding to a banking transaction. One or more identification information servers may provide respective identification data associated with the individual that performed the banking transaction and the account involved in the banking transaction. A transaction analysis module may determine whether the first identification data matches the second identification data and generate banking transaction analysis data. The banking transaction analysis data may identify the banking transaction as a potential policy violation when the first identification data matches the second identification data.

According to one or more additional aspects, computer-readable media having computer executable instructions for analyzing electronic transactions are also provided. Transaction data corresponding to an electronic transaction may be received from a transaction data store. Identification data associated with an individual that performed the electronic transaction may be obtained. Identification data associated with a second individual that is associated with the electronic transaction may also be obtained. The respective identification data for the individuals may be compared to determine whether the identification data for the first individual matches the identification data for the second individual. Transaction analysis data may be generated that identifies the electronic transaction as a potential policy violation when the identification data associated with the individuals match.

In some embodiments, the identification data may include addresses (e.g., a home address, emergency contact address, or customer profile address), a phone number, an email address, a surname, a social security number, a joint account identifier, and combinations of such. When the identification information includes addresses, the addresses may be normalized, e.g., by a normalization engine, to expand street suffix abbreviations and to remove special characters. A comparison engine may compare the identification data to generate the transaction analysis data, and a transaction analysis report may be generated based on the transaction analysis data.

### BRIEF DESCRIPTION OF THE DRAWINGS

Aspects of the disclosure may be implemented in certain parts, steps, and embodiments that will be described in detail in the following description and illustrated in the accompanying drawings in which like reference numerals indicate similar elements. It will be appreciated with the benefit of this disclosure that the steps illustrated in the accompanying figures may be performed in other than the recited order and that one or more of the steps disclosed may be optional. It will also be appreciated with the benefit of this disclosure that one or more components illustrated in the accompanying figures may be positioned in other than the disclosed arrangement and that one or more of the components illustrated may be optional.

FIG. 1 is a block diagram of an example operating environment in which various aspects of the disclosure may be implemented.

FIG. 2 is a block diagram of example workstations and servers that may be used to implement the processes and functions of one or more aspects of the present disclosure.

FIG. 3 is a block diagram of an example transaction analysis system in accordance with one or more aspects of the present disclosure.

FIG. 4 is a block diagram of example relationships between address information, accounts, transactions, and associates.

FIG. 5 is a block diagram of an example of an implementation of a transaction analysis system.

FIG. 6 is a flowchart of example method steps for analyzing transactions to identify potential policy violations.

FIG. 7 is another flowchart of example methods steps for analyzing banking transactions.

FIG. 8 is an example of an implementation of a transaction analysis report.

### DETAILED DESCRIPTION

Aspects of the present disclosure are directed towards monitoring banking transactions to ensure compliance with the internal policies of a banking institution. Although the present disclosure proceeds in the context of banking transactions, it will be appreciated that the concepts discussed below may be employed in alternative contexts for alternative types of transactions. Stated generally, a banking institution may compile and analyze transaction data to determine whether a banking employee potentially violated an internal policy by performing a particular transaction. Banking policies may prohibit employees from performing transactions for themselves or for anyone they have a relationship with, e.g., a personal or professional relationship. For example, banking policies prohibit employees from performing transactions for themselves or for their spouses. A banking institution may thus employ a transaction analysis system to identify transactions that potentially violate banking policies. The transaction analysis system may generate transaction analysis data, which may be used to generate a transaction analysis report. The transaction analysis report may identify any transactions that potentially violate banking policies. Details regarding the transaction analysis system and the process of monitoring and analyzing transactions are discussed in further detail below.

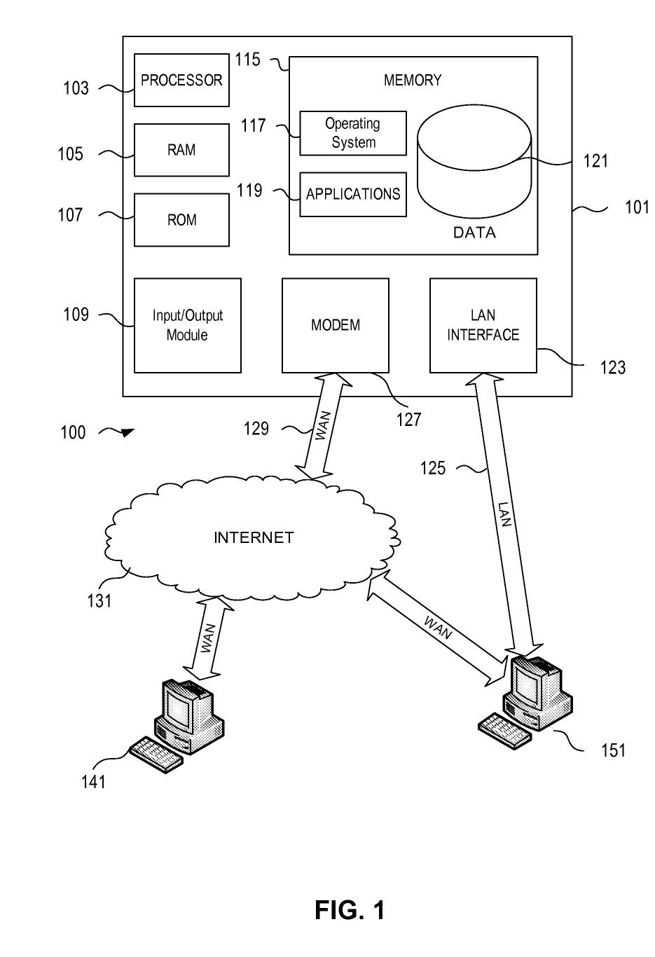

FIG. 1 illustrates a block diagram of transaction analysis system 101 (e.g., a computer server) in communication system 100 that may be used according to an illustrative embodiment of the disclosure. The system 101 may have a processor 103 for controlling overall operation of the system and its associated components, including RAM 105, ROM 107, input/output (I/O) module 109, and memory 115.

I/O 109 may include a microphone, keypad, touch screen, and/or stylus through which a user of the enhanced backup and retention management module 101 may provide input, and may also include one or more of a speaker for providing audio output and a video display device for providing textual, audiovisual and/or graphical output. Software may be stored within memory 115 and/or storage to provide instructions to processor 103 for enabling the system 101 to perform various functions. For example, memory 115 may store software used by the system 101, such as an operating system 117, application programs 119, and an associated database 121. Processor 103 and its associated components may allow the system 101 to run a series of computer-readable instructions to monitor and analyze transactions.

The system 101 may operate in a networked environment supporting connections to one or more remote computers, such as terminals 141 and 151. The terminals 141 and 151 may be personal computers or servers that include many or all of the elements described above relative to the system 101. Alternatively, terminal 141 and/or 151 may be a data store that is affected by the backup and retention policies stored on the system 101. The network connections depicted in FIG. 1 include a local area network (LAN) 125 and a wide area network (WAN) 129, but may also include other networks. When used in a LAN networking environment, the system 101 is connected to the LAN 125 through a network interface or adapter 123. When used in a WAN networking environment, the system 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, one or more application programs 119 used by the transaction analysis system 101 according to an illustrative embodiment of the disclosure may include computer executable instructions for invoking functionality related to analyzing transaction data.

The transaction analysis system 101 and/or terminals 141 or 151 may also be mobile terminals, such as smart phones, personal digital assistants (PDAs), etc. including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, and the like that perform particular tasks or implement particular abstract data types. The disclosure may also be practiced in distributed computing environments where tasks are performed by remote processing devices that are linked, for example, through a communications network. In a distributed computing environment, program modules may be located in both local and remote computer storage media including memory storage devices.

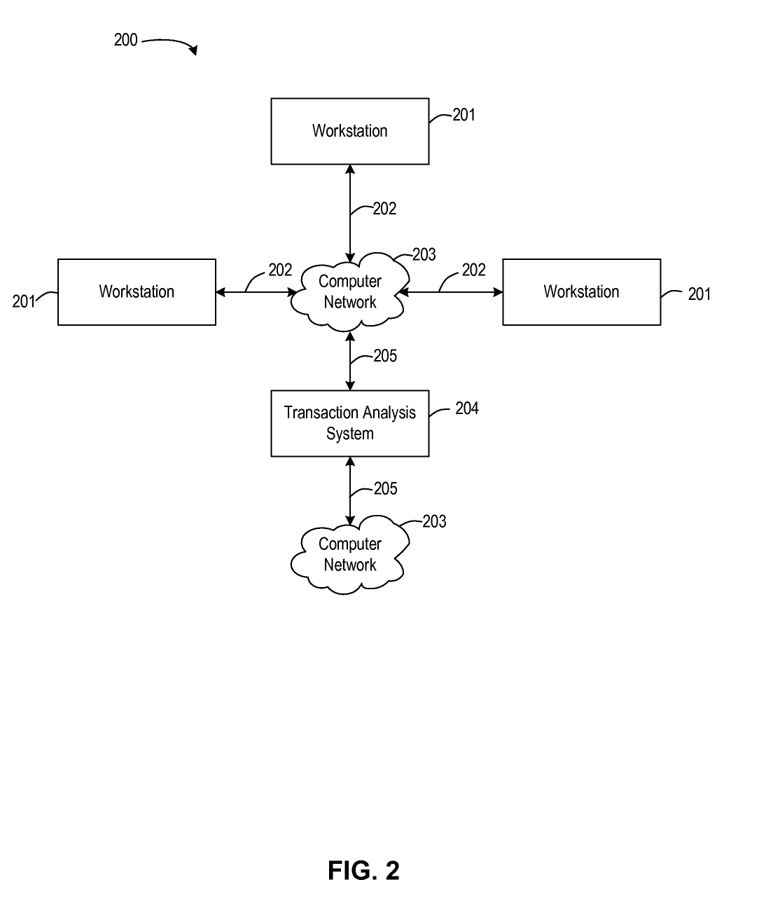

Referring to FIG. 2, an illustrative system 200 for implementing methods according to the present disclosure is shown. As illustrated, system 200 may include one or more workstations/servers 201. Workstations 201 may be local or remote, and are connected by one or more communications links 202 to computer network 203 that is linked via communications links 205 to the transaction analysis system 204. In certain embodiments, workstations 201 may be different servers that have backup and retention policies tracked by the transaction analysis system 204, or, in other embodiments, workstations 201 may be different points at which the transaction analysis system 204 may be accessed. In system 200, the transaction analysis system 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and the transaction analysis system 204, such as network links, dial-up links, wireless links, hard-wired links, etc.

The disclosure that follows in the figures may be implemented by one or more of the components in FIG. 1 and FIG. 2 and/or other components, including other computing devices.

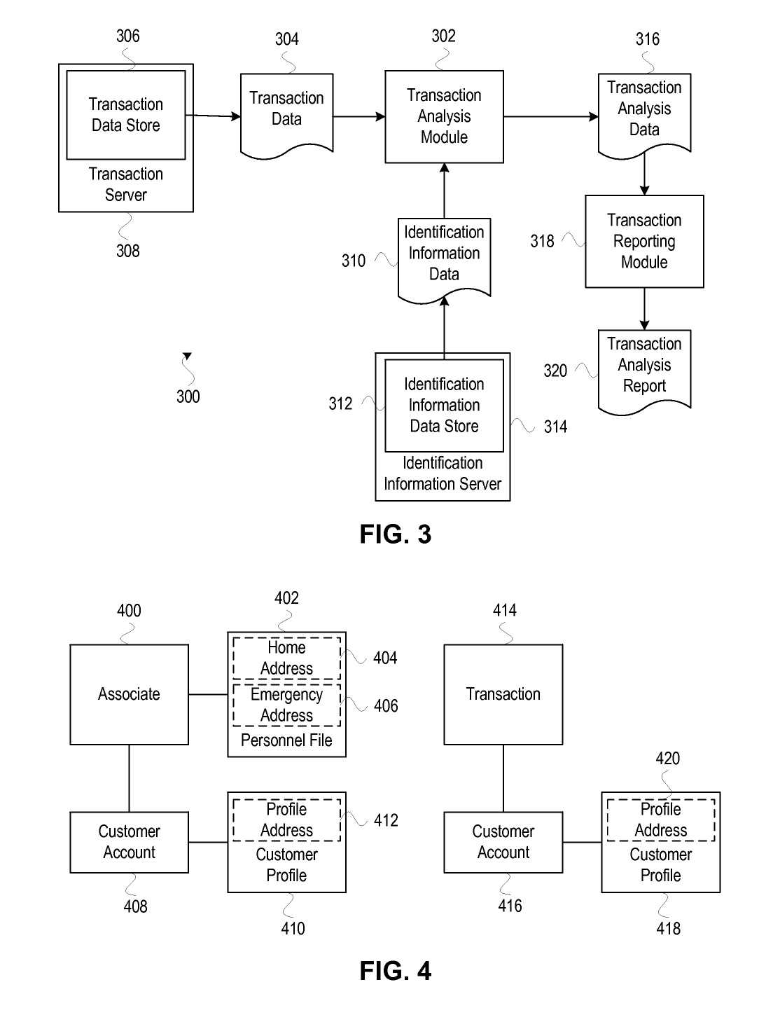

Referring now to FIG. 3, a block diagram of an example transaction analysis system 300 in accordance with one or more aspects of the present disclosure is shown. The transaction analysis system 300, in this example, includes a transaction analysis module 302 that receives transaction data 304 from a transaction data store 306 residing at a transaction server 308. The transaction analysis system 302, in this example, also receives identification information data 310 from an identification information data store 312 residing at an identification information server 314. The transaction analysis module 302 processes and analyzes the transaction data 304 and the identification information data 310 to generate transaction analysis data 314. The transaction analysis module 302 may provide the transaction analysis data to a transaction reporting module 318, and the transaction reporting module may process the transaction analysis data to generate a transaction analysis report 320. The transaction analysis report 320 may identify any transactions that correspond to potential policy violations.

Employees of the banking institution may carry out different types of transactions. In the present disclosure, a banking employee is referred to as an associate. An associate may work in one or more departments of a banking institution, e.g., as a teller, account representative, call center representative, customer service representative, and the like. Additional and alternative roles will be appreciated by those familiar with banking institutions. In their various roles, associates may perform various types of transactions, e.g., processing account deposits, withdrawals, or transfers of funds; issuing credits or refunds; opening new accounts or closing existing accounts; issuing new credit cards or debit cards; changing, updating, and/or otherwise modifying accountholder information (e.g., name, address, telephone number, email address, and the like) for one or more accounts; and so forth. Other types of transactions will also be appreciated by those familiar with banking institutions.

The transaction data store 306 may store transaction data corresponding to the transactions performed by associates. The transaction data 304 may identify, e.g., the associate that performed the transaction, the date the transaction was performed, the account associated with the transaction, the customer associated with the transaction, and other details describing the nature of the transaction. The transaction data store 306 may implement a transaction data model used to store and establish relationships between transaction data, account data, customer data, and associate data. The transaction server 308 may include a database management system (not shown) that facilitates storage and retrieval of the transaction data 304 at the transaction data store 306. It will be appreciated that a banking institution may maintain multiple transaction servers 308 corresponding to the various departments of the institution as described in further detail below.

The identification information data 310 may refer to information that identifies the associate that performed the transaction as well as the customer associated with the account involved in the transaction. In some situations, a transaction may be associated with multiple accounts, e.g., an account transfer is associated with originating account and a destination account. Like the transaction data store 306, the identification information data store 312 may implement a data model used to store and establish relationships between identification information data. The identification information server 314 may likewise include a database management system (not shown) that facilitates storage and retrieval of the identification information data 310 at the identification information data store 312. It will thus also be appreciated that a banking institutions may maintain multiple identification information servers 314 as described in further detail below. When analyzing the transaction data 304, the transaction analysis module 302 may query the identification information server for identification information 310 associated with the transactions. The identification information server 314 may provide the requested identification information 310 in response to the query.

The transaction analysis module 302 may utilize the identification information 310 to determine whether a transaction potentially violates a banking policy. As noted above, banking policies may prohibit associates from performing transactions for themselves or individuals they have a relationship with. To identify potential policy violations, the transaction analysis module 302 may compare identification information for an associate that performed a transaction to identification information for the account involved in the transaction. If the identification information for the associate matches the identification information for the account involved in the transaction, then the transaction analysis module 302 may flag the transaction as a potential policy violation.

As discussed in further detail below, one type of identification information the transaction analysis module 302 may use to identify potential policy violations is address information, e.g., a mailing address. In this example, if an address for an associate matches an address for the account involved in the transaction, the transaction analysis module 302 may flag the transaction as a potential policy violation. Using address information to identify potential policy violations is discussed in further detail below. It will be appreciated with the benefit of this disclosure, however, that the transaction analysis module 302 may employ additional and/or alternative types of identifying information when analyzing transactions. Other types of identifying information may include, e.g., identifiers linking individuals that share a joint account (which may be referred to as “joint account identifiers”), phone numbers, email addresses, social security numbers, surnames, other types of identifying information, and combinations of such.

The transaction analysis module 302 may process the transaction data 304 to generate the transaction analysis data 316. The transaction analysis data 316 may identify any transactions that correspond to potential policy violations as well as the matching identification information that caused the transaction analysis module 302 to flag the transaction. The transaction analysis data 316 may be in a raw data format and provided to the transaction reporting module 318 for further processing. The transaction reporting module may reformat and arrange the raw transaction analysis data 316 to generate the transaction analysis report 320. A transaction analyst may thus review the report and determine whether any flagged transactions should be escalated to full investigations. Although the transaction reporting module 318 is shown as a separate component in FIG. 3, it will be appreciated that, in some example implementations, the transaction reporting module may be a sub-component of the transaction analysis module 302.

The transaction server 308 may compile the transaction data 304 over a period of time and periodically upload the transaction data 304 to the transaction analysis module for processing and analysis. For example, a banking institution may upload the transaction data 304 on a weekly basis to identify any potential policy violations. The transaction data 304 may be manually uploaded to the transaction analysis server, or in some example implementations, the transaction server 308 may be configured to automatically upload the transaction data on a periodic basis. In this regard, the entire transaction monitoring and analysis process may be automated such that the transaction analysis module 302 automatically analyzes the transaction data 304 and the transaction reporting module automatically generates the transaction analysis report 320. Accordingly, a transaction analyst may advantageously receive regular transaction analysis reports 318 without further interaction once the automated system 300 is initially set up and configured.

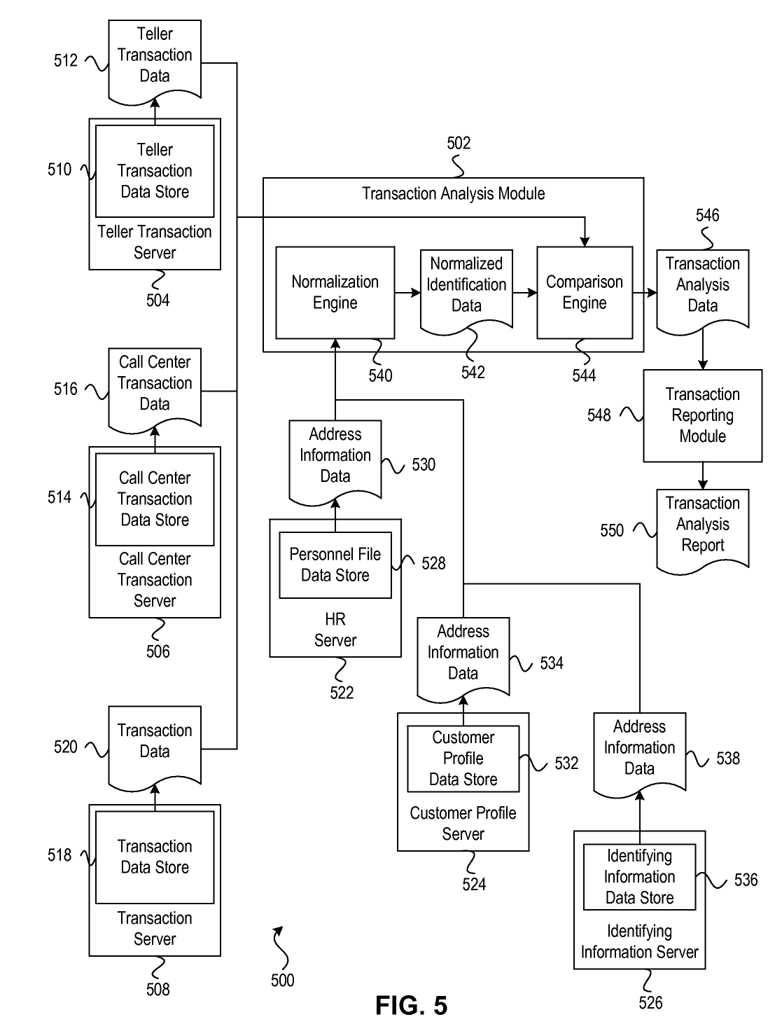

FIG. 4 is a block diagram of the example relationships between address information and accounts, transactions, and associates. As seen in FIG. 4, an associate 400 may be associated with a personnel file 402 that includes various types of personal information for the associate. The personal information may include addresses for the associate including, e.g., a home address 404 and an emergency contact address 406. In some circumstances, the associate 400 may be a customer of the banking institution and thereby maintain a customer account 408 with the banking institution. The customer account 408 may be associated with a customer profile 410 that similarly stores various types of personal information for the customer. The personal information for the customer may include one or more addresses for the customer, e.g., a customer profile address 412. A banking institution may store records of the personnel files 402 for associates 400 at a personnel file data store (FIG. 5). Similarly, a banking institution may store records of the customer profiles at a customer profile data store (FIG. 5). A transaction management module 302 may query the personnel file data store and the customer profile data store for the address information of an associate when analyzing the transaction data 304.

As noted above, a transaction 414 may also be associated with a customer account 416. The customer account 416 for the transaction 414 may likewise be associated with a customer profile 418 that includes personal information such as a customer profile address 420. A transaction analysis module 302 may similarly query the customer profile data store for the address information associated with a transaction when analyzing the transaction data 304. As seen in FIG. 4, a transaction analysis system may compare the address information associated with a transaction 414 to the address information associated with the associate 400 that performed the transaction. As an example, if the profile address 420 of the customer profile 418 associated with the transaction 414 matches any of the home address 404, emergency address 406, or profile address 412 of the associate that performed the transaction, the transaction analysis module 302 may determine that the transaction was performed for the associate or for someone the associate has a relationship with. In response to such a determination, the transaction analysis module 302 may flag the transaction as a potential policy violation. As described above, the personnel file 402 or the customer profiles 410 and 418 may include additional or alternative identifying information that the transaction analysis module 302 may utilize when processing the transaction data 304.

In FIG. 5, an example of an implementation of a transaction analysis system 500 is shown. Like the transaction analysis system 300 in FIG. 3, the transaction analysis system 500 may include a transaction analysis module 502 to process and analyze transaction data. In this example, the transaction analysis module 502 is in signal communication with a teller transaction server 504, a call center transaction server 506, and another transaction server 508. The teller transaction service may include a teller transaction data store 510 that stores teller transaction data 512; the call center transaction server 506 may include a call center transaction data store 514 that stores call center transaction data 516; and the other transaction server 508 may include a transaction data store 518 that stores other types of transaction data 520.

The transaction analysis module 502, in this example, may also be in signal communication with a human resources (HR) server 522, a customer profile server 524, and another identifying information server 526. The HR server 522 may include a personnel file data store 528 that stores address information 530 for associates of the banking institution; the customer profile server 524 may include a customer profile data store 532 that stores address information 534; and the other identifying information server 526 may include an identifying information data store 536 that also stores address information 538. The transaction analysis module 502 may query these data stores 522, 524, and 526 when processing the transaction data 512, 516, and 520.

It will be appreciated that in some instances, the address information received from the various servers 522, 524, and 526 may be inconsistently formatted. In order to accurately compare the address information, the transaction analysis module 502, in this example, may include a normalization engine 540. The normalization engine 540 may take as input the address information data 530, 534, and 530 and may generate as output normalized identification data 542, e.g., normalized address data. In particular, the normalization engine 540 may expand street suffix abbreviations and remove special characters from the address information data 530, 534, and 538. During the normalization process, for example, the normalization engine may expand “Pkwy” to “Parkway,” “St” to “Street,” “Ave” to “Avenue” and so forth. Additionally, the normalization engine 540 may remove special characters and punctuation marks such as quotes—“ ”, apostrophes—‘ ’, parentheses—( ), brackets—[ ], braces—{ }, slashes—/ \, colons—:, semicolons—;, guillemets—<< >>, exclamation points—!, ampersats—@, hash signs—#, dollar signs—$, percent signs—%, carats—̂, ampersands—&, asterisks—*, bullets—•, question marks—?, and other non-alphabetic and non-numeric characters. By normalizing the address information data 530, 534, and 538 to obtain the normalized address data 542, the address associated with the transaction may be accurately compared to the addresses associated with the associate that performed the transaction. It will be appreciated that the normalization engine 540 may, in other instances, similarly normalize other types of identification information such as phone numbers, email addresses, other types of personal information that may be associated with a customer, and the like.

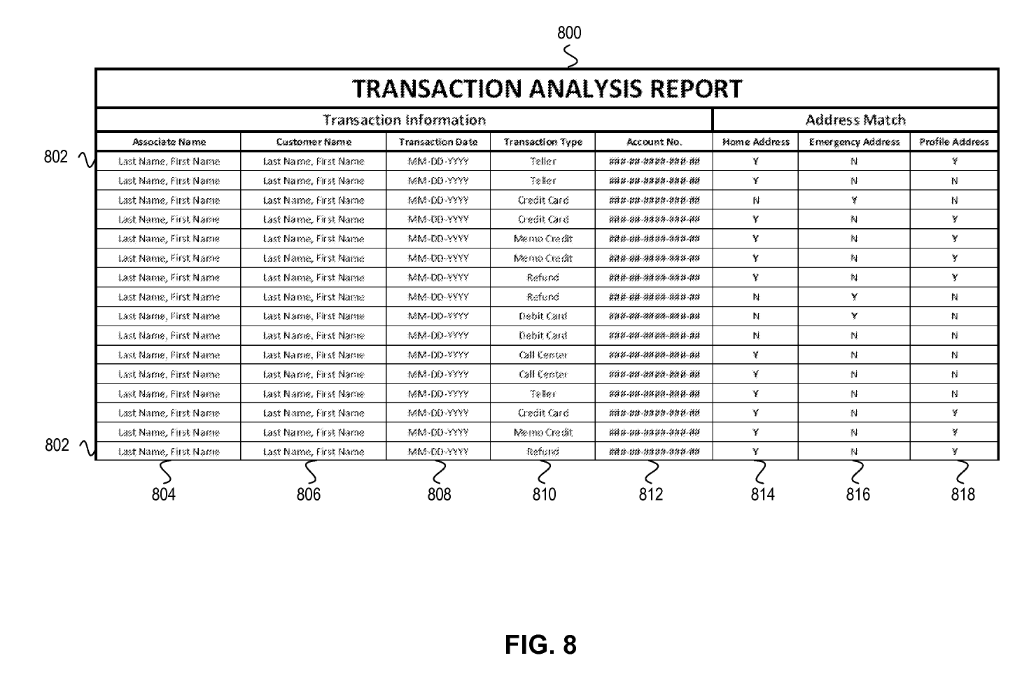

The transaction analysis module 502, in this example, also includes a comparison engine 544 that may compare the normalized identification data associated with the various transactions. The comparison engine 544 may generate the resulting transaction analysis data 546 that indicates whether any transaction potentially violates banking policies. The process of comparing address information is discussed below in further detail. The resulting transaction analysis data 546 may include, e.g., a unique identifier for a transaction, information identifying the associate that performed the transaction, information identifying the account involved in the transaction, information indicating any matching addresses, and other information associated with the transaction. As noted above, the transaction analysis data 546 may be in a raw format, and the transaction analysis module 502 may provide the transaction analysis data to a transaction reporting module 548. The transaction reporting module 548 may generate a transaction analysis report 550 with the transaction analysis data 546 reformatted and arranged in a more readable format. An example transaction analysis report is shown in FIG. 8.

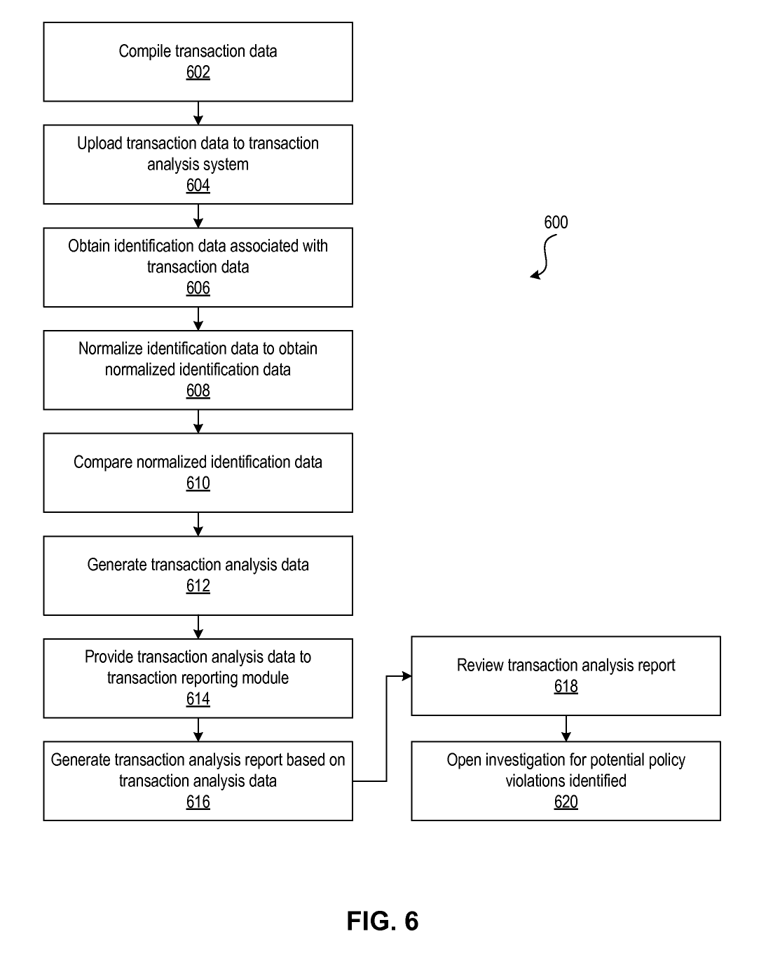

In FIG. 6, a flowchart 600 of example method steps for analyzing transactions to identify potential policy violations is shown. An organization may compile transaction data that describes transactions performed by that organization (block 602). The organization may be, e.g., a banking institution, and the transactions may be various types of banking transactions as described above. For banking transactions, the transaction data may include, e.g., information that identifies the associate that performed the transaction, the account involved in the transaction, and the customer associated with the account. The transaction data may be uploaded to a transaction analysis system for processing (block 604). The transaction analysis system may obtain identification data respectively associated with the transaction data as part of the analysis process (block 606). The transaction system may obtain identification data for each transaction identified in the transaction data. Where the transactions are banking transactions, for example, the identification data may include address information associated with the associate that performed the transaction as well as address information associated with account involved in the transaction.

As noted above, the identification data respectively associated with the transactions may have different formats. Accordingly, the transaction analysis system may normalize the identification data before using the identification data in one or more comparisons (block 608). In this way, the transaction analysis system advantageously may increase the likelihood of identifying matching identification information as well as the accuracy and reliability of the analysis process. Where the identification information includes address information, the transaction analysis system may expand street suffixes and remove special characters in order to normalize the address information. The transaction analysis system may compare the normalized identification data to determine whether a transaction corresponds to a potential policy violation (block 610). With respect to banking transactions, the transaction analysis system may identify a potential policy violation where the address information of the associate that performed the transaction matches the address information associated with the account involved in the transaction. Through the transaction analysis process, the transaction analysis system may generate transaction analysis data (block 612). The transaction analysis data may include information identifying transactions that correspond to potential policy violations. In some example implementations, the transaction analysis data may include information for each transaction analyzed regardless of whether the transaction corresponds to potential policy violations. In other example implementations, the transaction analysis data may only include information for transactions that correspond to potential policy violations and omit information regarding transactions that do not represent potential policy violations.

The transaction analysis data may be provided to a transaction reporting module (block 614) to generate a transaction analysis report based on the transaction analysis data (block 616). An analyst may review the transaction analysis report (block 618) to determine how to respond to the potential policy violations. In some circumstances, for example, the analyst may determine to open an investigation into the potential policy violation (block 620).

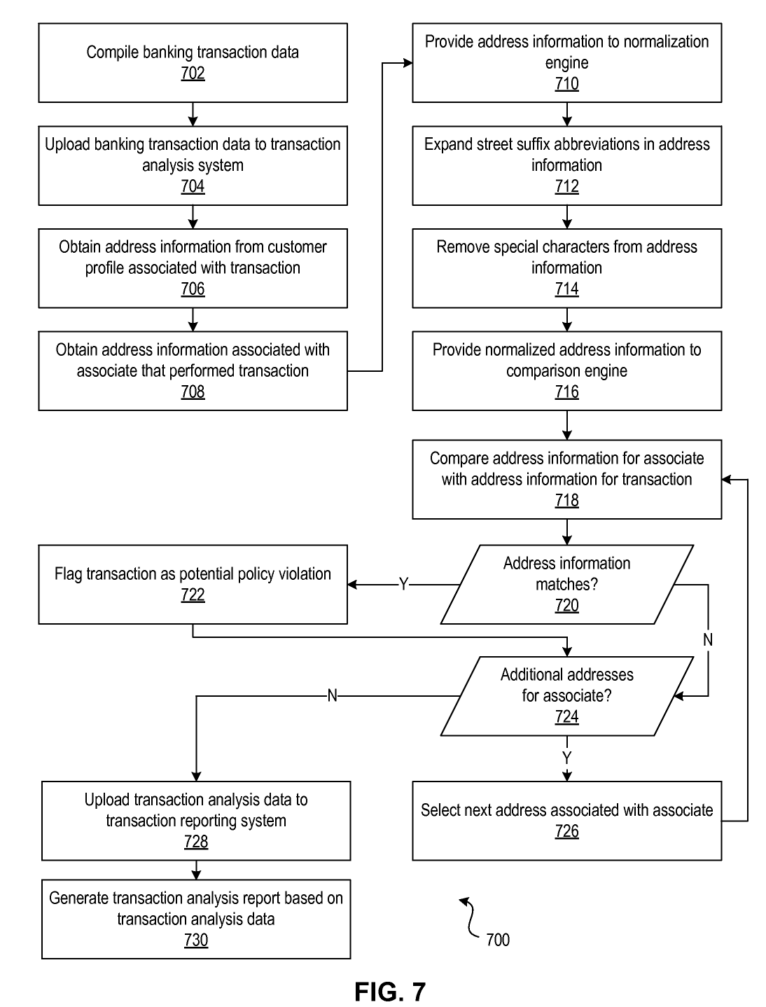

In FIG. 7, a flowchart 700 of example method steps for analyzing banking transactions by comparing address information is shown. A banking institution may compile banking transaction data for various types of banking transactions (block 702) and upload the banking transaction data to a transaction analysis system (block 704). The transaction analysis system may obtain address information from the customer profile of the account involved in the transaction (block 706) as well as address information for the associate that performed the transaction (block 708). The address information may be provided to a normalization engine for normalization (block 710). During the normalization process, the normalization engine may expand the street suffixes in the address information (block 712) and remove any special characters from the address information (block 714) as described above.

Once the address information has been normalized, the normalization engine may provide the normalized address information to a comparison engine (block 716). The comparison engine may select one of the transactions in the transaction data and select the address information associated with the selected transaction. The comparison engine may then compare one of the addresses for the associate that performed the transaction with the address associated with the account involved in the transaction (block 718). As noted above, the addresses for the associate may be a personal address, an emergency contact address, and/or a customer profile address. If one of the addresses for the associate matches the address associate with the account involved in the transaction (block 720:Y), then the comparison engine may flag the transaction as a potential policy violation (block 722). If the address for the associate does not match (block 720:N), then the comparison engine may determine whether the address information includes additional addresses for the associate. If there are additional addresses for the associate (block 724:Y), then the comparison engine may select the next address for the associate (block 726) and repeat steps 718-724 to determine if the additional address matches the account address. If no additional associate addresses remain (block 724:N), the comparison engine may upload the transaction analysis data to a transaction reporting module (block 728) as described above. As also described above, the transaction reporting module may generate a transaction analysis report based on the transaction analysis data (block 730).

In FIG. 8, an example transaction analysis report 800 is shown. The transaction analysis report 800 in FIG. 8 presents transaction analysis data for banking transactions. The transaction analysis report 800, in this example, includes line items 802 corresponding to various banking transactions. The transaction analysis report 800 also may include multiple columns to present the transaction analysis data. As seen in FIG. 8, the transaction analysis report, in this example, includes an associate name column 804 that displays the name of the associate that performed the transaction, a customer name column 806 that displays the name of the customer associated with the account involved in the transaction, a transaction date column 808 that displays the date the transaction was performed, a transaction type column 810 that displays the type of transaction performed, and an account number column 812 that displays the account number of the account involved in the transaction.

The example transaction analysis report 800 in FIG. 8 also includes columns to indicate whether the address information for the associate matches the address information for the account involved in the transaction. The transaction analysis report 800, in this example, includes columns 814, 816, and 818 to respectively indicate whether the home address, emergency address, or customer profile address of the associate matches the address information associated with the account involved in the transaction. It will be appreciated that transaction analysis reports may include additional or alternative information related to the transactions, the associate, the account, the customer associated with the account, and/or the transaction analysis data. In some implementations, for example, the transaction analysis report may include the address information for easy reference upon review.

The approach to monitoring and analyzing the transaction described above provides numerous technical advantages. In particular, the transactional analysis system and method leverage the automated processing and storage capabilities of computing resources to compile and compare information related to the millions of electronic transactions regularly carried out by organizations such as banking institutions. Such organizations may thus process and analyze transactions relatively quickly and in a manner that minimizes the human effort in monitoring transactions for potential policy violations.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, the steps illustrated in the illustrative figures may be performed in other than the recited order, and one or more steps illustrated may be optional in accordance with aspects of the disclosure.

What is claimed is:

1. A computer-implemented method of analyzing banking transactions comprising:
collecting banking transaction data corresponding to a banking transaction;
obtaining first identification data associated with an individual that performed the banking transaction and second identification data associated with an account involved in the banking transaction;
determining whether the first identification data matches the second identification data; and
generating banking transaction analysis data that identifies the banking transaction as a potential policy violation in response to a determination that the first identification data matches the second identification data.

2. The computer-implemented method of claim 1 wherein:
the first identification data comprises first address data for the individual that performed the banking transaction; and
the second identification data comprises second address data for the account involved in the banking transaction.

3. The computer-implemented method of claim 2 wherein:
the first address data comprises a home address for the individual, an emergency contact address for the individual, and a customer profile address for the individual that performed the banking transaction;
the second address data comprises a customer profile address for the account involved in the banking transaction; and
determining whether the first identification data matches the second identification data includes
comparing the customer profile address for the account to each of the home address, the emergency contact address, and the customer profile address for the individual, and
determining that the first identification data matches the second identification data when the customer profile address for the account matches at least one of the home address, the emergency contact address, and the customer profile address for the individual.

4. The computer-implemented method of claim 2 wherein determining whether the first identification information matches the second identification information includes:
normalizing the first address data and the second address data to respectively obtain first normalized address data and second normalized address data;
comparing the first normalized address data to the second normalized address data; and
determining the first identification data matches the second identification data when the first normalized address data matches the second normalized address data.

5. The computer-implemented method of claim 4 wherein normalizing the first address data and the second address data includes:
expanding street suffix abbreviations included in the first address data and the second address data; and
removing non-alphabetic characters and non-numeric characters from the first address data and the second address data.

6. The computer-implemented method of claim 1 further comprising generating a banking transaction analysis report based on the banking transaction analysis data.

7. The computer-implemented method of claim 1 wherein the first identification data and the second identification data comprise at least one of a phone number, an email address, a surname, a social security number, a joint account identifier, and a combination thereof.

8. A transaction analysis system comprising:
a banking transaction server that is configured to collect banking transaction data corresponding to a banking transaction;
one or more identification information servers that are respectively configured to provide first identification data associated with an individual that performed the banking transaction and second identification data associated with an account involved in the banking transaction; and
a transaction analysis device configured to determine whether the first identification data matches the second identification data and, in response to a determination that the first identification data matches the second identification data, generate banking transaction analysis data that identifies the banking transaction as a potential policy violation.

9. The transaction analysis system of claim 8 wherein:
the first identification data comprises first address data for the individual that performed the banking transaction; and
the second identification data comprises second address data for the account involved in the banking transaction.

10. The transaction analysis system of claim 9 wherein:
the first address data comprises a home address for the individual, an emergency contact address for the individual, and a customer profile address for the individual that performed the banking transaction;
the second address data comprises a customer profile address for the account involved in the banking transaction;
the transaction analysis device is further configured to determine whether the first identification data matches the second identification data by comparing the customer profile address for the account to each of the home address, the emergency contact address, and the customer profile address for the individual; and
the transaction analysis device is further configured to determine that the first identification data matches the second identification data when the customer profile address for the account matches at least one of the home address, the emergency contact address, and the customer profile address for the individual.

11. The transaction analysis system of claim 9 wherein the transaction analysis device is further configured to provide:
a normalization engine that normalizes the first address data and the second address data to respectively obtain first normalized address data and second normalized address data;
a comparison engine that compares the first normalized address data to the second normalized address data; and
wherein the transaction analysis device is further configured to determine that the first identification data matches the second identification data when the first normalized address data matches the second normalized address data.

12. The transaction analysis system of claim 11 wherein the normalization engine normalizes the first address data and the second address data by:
expanding street suffix abbreviations included in the first address data and the second address data; and
removing non-alphabetic characters and non-numeric characters from the first address data and the second address data.

13. The transaction analysis system of claim 8 wherein the transaction analysis device is further configured to provide a transaction reporting module that generates a banking transaction analysis report based on the banking transaction analysis data.

14. The transaction analysis system of claim 8 wherein the first identification data and the second identification data comprise at least one of a phone number, an email address, a surname, a social security number, a joint account identifier, and a combination thereof.

15. A non-transitory computer-readable medium having computer-executable instructions stored thereon that, when executed by a processor of a computing device, cause the computing device to:
receive, from a transaction data store, transaction data corresponding to an electronic transaction;
obtain, from one or more identification information data stores, first identification data associated with a first individual that performed the electronic transaction and second identification data associated with a second individual associated with the transaction;
determine whether the first identification data matches the second identification data; and
generate transaction analysis data that identifies the electronic transaction as a potential policy violation in response to a determination that the first identification data matches the second identification data.

16. The computer-readable medium of claim 15 wherein:
the first identification data comprises first address data for the first individual that performed the electronic transaction; and
the second identification data comprises second address data for the second individual associated with the electronic transaction.

17. The computer-readable medium of claim 16 having additional computer-executable instructions stored thereon that, when executed by the processor of the computing device, further cause the computing device to:
normalize the first address data and the second address data to respectively obtain first normalized address data and second normalized address data;
compare the first normalized address data to the second normalized address data; and
determine the first identification data matches the second identification data when the first normalized address data matches the second normalized address data.

18. The computer-readable medium of claim 17 having additional computer-executable instructions stored thereon that, when executed by the processor of the computing device, further cause the computing device to:
expand street suffix abbreviations included in the first address data and the second address data; and
remove non-alphabetic characters and non-numeric characters from the first address data and the second address data.

19. The computer-readable medium of claim 17 having additional computer-executable instructions stored thereon that, when executed by the processor of the computing device, further cause the computing device to generate a transaction analysis report based on the transaction analysis data.

20. The computer-readable medium of claim 15 wherein the first identification data and the second identification data comprise at least one of a phone number, an email address, a surname, a social security number, a joint account identifier, and a combination thereof.
